(19) United States
(12) Patent Application Publication
(10) Pub. No.: US 2023/0039275 A1
(43) Pub. Date: Feb. 9, 2023

(54) WELDING METHOD AND WELDED STRUCTURE

(71) Applicant: SHINDENGEN ELECTRIC MANUFACTURING CO., LTD., Tokyo (JP)

(72) Inventor: Tomomi NAKAMURA, Hanno-shi (JP)

(21) Appl. No.: 17/782,335

(22) PCT Filed: Dec. 13, 2019
(86) PCT No.: PCT/JP2019/048858

§ 371 Date: Jun. 3, 2022

(51) Int. Cl. B23K 26/18; B23K 26/21

(52) U.S. Cl. CPC B23K 26/18; B23K 26/21; B23K 2103/12

(57) ABSTRACT

To arrange an auxiliary member (2) having a greater absorption rate of laser light (LL) than a plurality of members (1) to be joined to each other so as to face a boundary exposed surface (12) of the plurality of members to be joined where a boundary (11) of the plurality of members to be joined is exposed, to melt the auxiliary member by applying laser light to the auxiliary member, to shift a boundary portion (13) in a state where laser light is easily absorbed by increasing a temperature of the boundary portion of the plurality of members to be joined by a melted portion (23) of the auxiliary member, and to weld a plurality of members to be joined by applying laser light to the boundary portion and melting the boundary portion.

### TECHNICAL FIELD

The present invention relates to a welding method and a welded structure.

### BACKGROUND ART

Patent Document 1 discloses a welding method in which a plurality of members to be joined are joined to each other by laser welding. In laser welding, electricity does not pass through the member to be joined during welding, and the range affected by heat during welding can be maintained to be small; therefore, there is an advantage in that an effect of welding on electronic portions (electrical effect or thermal effect) is small.

### CITATION LIST

### Patent Document

### [Patent Document 1]

Japanese Unexamined Patent Application, First Publication No. H10-334957

### SUMMARY OF INVENTION

### Technical Problem

However, when an output of the laser light used for laser welding is small, it is difficult to join a member to be joined having a low absorption rate of laser light (i.e., laser absorption rate) such as copper by laser welding.

The present invention has been made in view of the above circumstances, and an object is to provide a welding method and a welded structure capable of easily welding a member to be joined having a low laser absorption rate even in laser welding in which the output of laser light is small.

### Solution to Problem

A welding method according to one aspect of the present invention comprises arranging an auxiliary member having a greater absorption rate of a laser light than a plurality of members to be joined to each other so as to face a boundary exposed surface of the plurality of members to be joined where a boundary of the plurality of members to be joined is exposed, melting the auxiliary member by applying a laser light to the auxiliary member, shifting a boundary portion in a state where a laser light is easily absorbed by increasing a temperature of the boundary portion of the plurality of members to be joined by a melted portion of the auxiliary member, and welding a plurality of members to be joined by applying a laser light to the boundary portion and melting the boundary portion.

A welded structure according to one aspect of the present invention comprises a plurality of members to be joined, and an auxiliary member arranged so as to face a boundary exposed surface of the plurality of members to be joined where a boundary of the plurality of members to be joined is exposed and having a greater absorption rate of a laser light than the plurality of members to be joined to each other, and the plurality of members to be joined and the auxiliary member are joined to each other by an alloy portion comprising components of the plurality of members to be joined and the auxiliary member.

### Advantageous Effects of Invention

According to the present invention, even in laser welding in which the output of laser light is small, it is possible to easily weld a member to be joined having a low laser absorption rate.

### BRIEF DESCRIPTION OF DRAWINGS

FIG. 1 is a cross-sectional view showing a welding method according to the first embodiment of the present invention.

FIG. 2 is a cross-sectional view showing a welding method according to the first embodiment of the present invention.

FIG. 3 is a cross-sectional view showing a welding method according to the first embodiment of the present invention.

FIG. 4 is a cross-sectional view showing a welding method and a welded structure according to the first embodiment of the present invention.

FIG. 5 is a perspective view showing a welding method according to the first embodiment of the present invention and a welded structure of a first example.

FIG. 6 is a cross-sectional view taken along the line VI-VI of FIG. 5.

FIG. 7 is a cross-sectional view showing a state before attaching an auxiliary member to three members to be joined in FIGS. 5 and 6.

FIG. 8 is a perspective view showing a welding method according to the first embodiment of the present invention and a welded structure of a second example.

FIG. 9 is a plan view of FIG. 8.

FIG. 10 is a cross-sectional view taken along the line X-X of FIG. 9.

FIG. 11 is a perspective view showing the plurality of members to be joined and an auxiliary member used in a welding method according to the second embodiment of the present invention.

FIG. 12 is a cross-sectional view taken along the line XII-XII of FIG. 11.

FIG. 13 is a cross-sectional view showing the welding method and the welded structure according to the second embodiment of the present invention.

FIG. 14 is a cross-sectional view showing a modification example of the plurality of members to be joined and an auxiliary member used in the welding method according to the second embodiment of the present invention.

### DESCRIPTION OF EMBODIMENTS

### First Embodiment

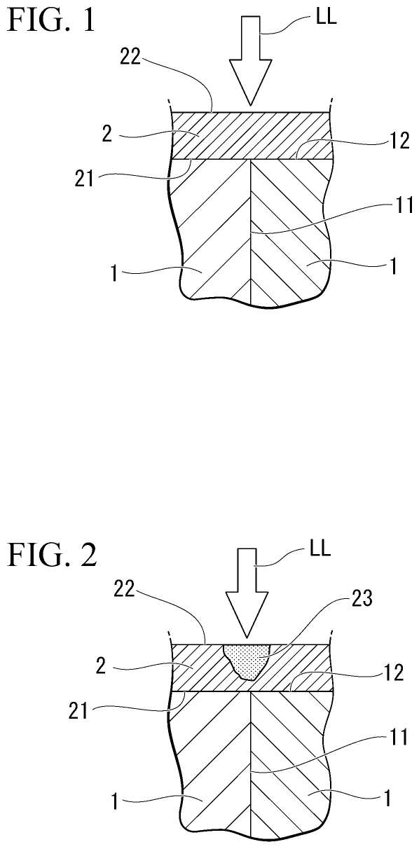

Hereinafter, the first embodiment of the present invention will be described with reference to FIGS. 1 to 10. As shown in FIGS. 1 to 4, a welding method according to the present embodiment is a method of joining two members to be joined 1 to each other by using laser light LL.

As shown in FIG. 1, in the welding method of the present embodiment, two members to be joined 1 and an auxiliary member 2 are first prepared. The materials of the two members to be joined 1 may be, for example, the same or different. The auxiliary member 2 is a material having a greater absorption rate of the laser light LL (hereinafter referred to as laser absorption rate) than that of the member to be joined 1. In addition, the auxiliary member 2 is a material having a melting point greater than that of the member to be joined 1. For example, when the member to be joined 1 is copper (Cu). stainless steel (SUS) can be used for the auxiliary member 2. When the laser light LL is the laser light of a fiber laser, the laser absorption rate of copper is approximately 2% and the laser absorption rate of stainless steel is approximately 25%.

Next, the two members to be joined 1 are arranged such that the two members 1 are in contact with each other and a boundary exposed surface 12 of the two members 1 where a boundary 11 of the two members 1 appears is flush with each other. In addition, the auxiliary member 2 is arranged such that the auxiliary member 2 faces and contacts the boundary exposed surface 12 of the two members to be joined 1. In such a state, a facing surface 21 of the auxiliary member 2 facing the two members to be joined 1 comes into surface contact with the boundary exposed surface 12. Both the boundary exposed surface 12 and the facing surface 21 of the auxiliary member 2 are formed on a flat surface. In addition, the auxiliary member 2 is formed in a plate shape in which the direction in which the facing surface 21 and an opposite surface 22 facing the opposite side of the facing surface 21 are lined up is the plate-thickness direction.

After that, the laser light LL is applied to the opposite surface 22 of the auxiliary member 2 to melt the auxiliary member 2. In particular, the laser light LL is applied to a position overlapping with (or the vicinity area of) the boundary 11 between the two members to be joined 1 in the direction in which the member to be joined 1 and the auxiliary member 2 are lined up (i.e., a plate-thickness direction of the auxiliary member 2) in the opposite surface 22 of the auxiliary member 2. The laser light IL may be applied not to the position overlapping the boundary 11 but to another position on the opposite surface 22 of the auxiliary member 2 depending on the output of the laser light LL, the diameter of the focal point, or the size of the member to be joined 1.

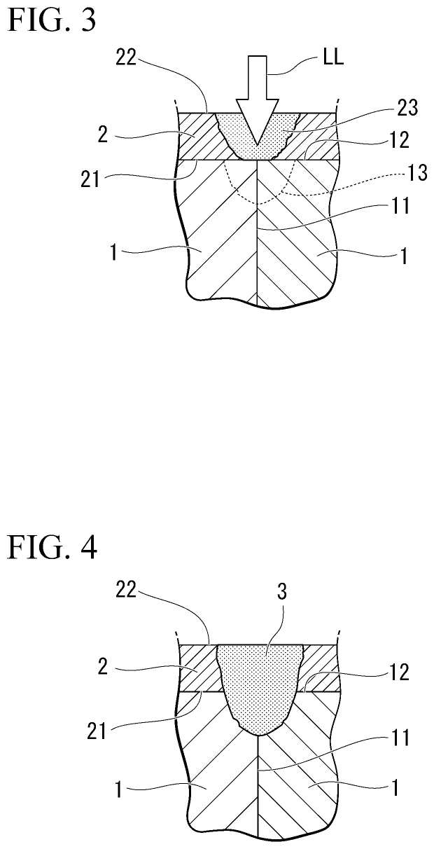

When the laser light LL is applied to the opposite surface 22 of the auxiliary member 2, as shown in FIG. 2, the portion of the auxiliary member 2 on a side of the opposite surface 22 is first melted. Reference numeral 23 in FIG. 2 indicates a melted portion of the auxiliary member 2. After that, as shown in FIG. 3, the portion of the auxiliary member 2 on a side of the facing surface 21 is also melted, and the melted portion 23 of the auxiliary member 2 reaches the facing surface 21 of the auxiliary member 2 and the boundary exposed surface 12 of the two members to be joined 1 which are in contact with the facing surface 21. Then, as the temperature of the boundary exposed surface 12 and a boundary portion 13 of the two members to be joined 1 rises due to the melted portion 23 of the auxiliary member 2 and the laser light LL reaching the boundary exposed surface 12 of the two members to be joined 1, the boundary portion 13 is melted.

The temperature of the boundary exposed surface 12 and the boundary portion 13 of the two members to be joined 1 rises due to the melted portion 23 of the auxiliary member 2 so that the boundary exposed surface 12 and the boundary portion 13 of the two members to be joined 1 are shifted to a state in which the laser light LL is easily absorbed, and the laser absorption rate of the boundary exposed surface 12 and the boundary portion 13 of the two members to be joined 1 becomes increased. Since the boundary exposed surface 12 and the boundary portion 13 of the two members to be joined 1 have a high laser absorption rate, they are heated not only by the heat of the melted portion 23 of the auxiliary member 2 but also by the laser light LL. As a result, the temperature of the boundary portion 13 of the two members to be joined 1 is more likely to rise, and the boundary portion 13 is more likely to melt.

As described above, when the boundary portion 13 of the auxiliary member 2 and the two members to be joined 1 is melted, as shown in FIG. 4, an alloy portion 3 including the components of the two members to be joined 1 and the auxiliary member 2 is formed. Then, the two members to be joined 1 and the auxiliary member 2 are joined to each other by the alloy portion 3. As described above, the welding method of the present embodiment in which the two members to be joined 1 are welded is completed. In such a welding method, the two members to be joined 1 may be arranged with a slight gap at the boundary 11. In addition, the two members to be joined 1 may be arranged in a state where the boundary exposed surface 12 is not flush with each other and has a slight step. The auxiliary member 2 may be arranged with a slight gap between the facing surface 21 of the auxiliary member 2 and the boundary exposed surface 12 of the two members to be joined 1.

As shown in FIG. 4, the welded structure obtained by the welding method of the present embodiment includes two members to be joined 1 and an auxiliary member 2 arranged so as to face the boundary exposed surface 12 thereof. In the welded structure, the two members to be joined 1 and the auxiliary member 2 are joined to each other by an alloy portion 3 including the components of the two members to be joined 1 and the auxiliary member 2. In the welding method described above, the alloy portion 3 is a combination of the melted portion 23 of the auxiliary member 2 (see FIGS. 2 and 3) and the melted portion of the two members to be joined 1.

In the above-mentioned welding method and welded structure, three or more members to be joined may be joined to each other by using the auxiliary member 2.

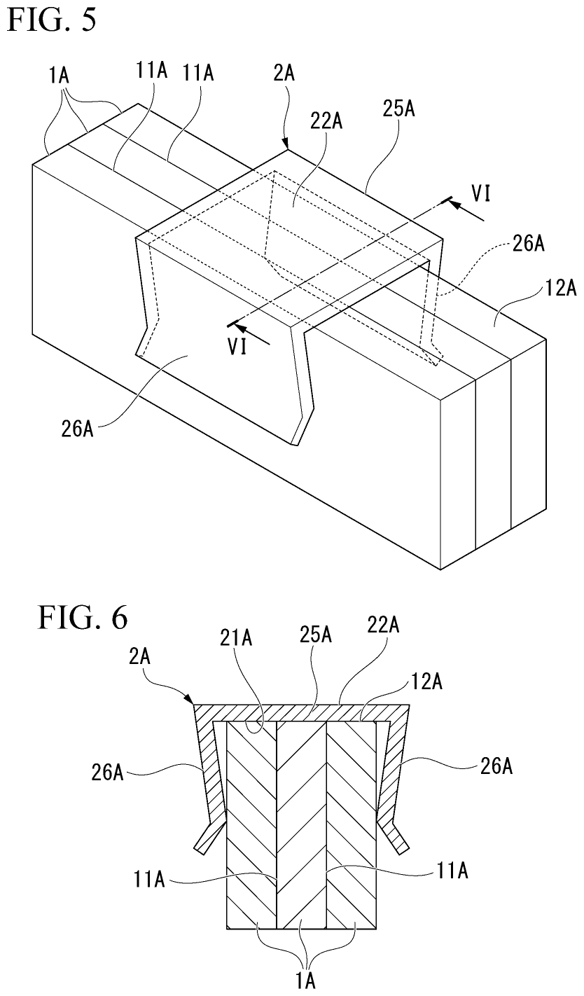

Next, the first embodiment of the present embodiment will be described with reference to FIGS. 5 to 7. The first embodiment is a welding method and a welded structure in which three plate-shaped members to be joined 1A are arranged so as to be stacked in the plate-thickness direction and the three members to be joined 1A are welded.

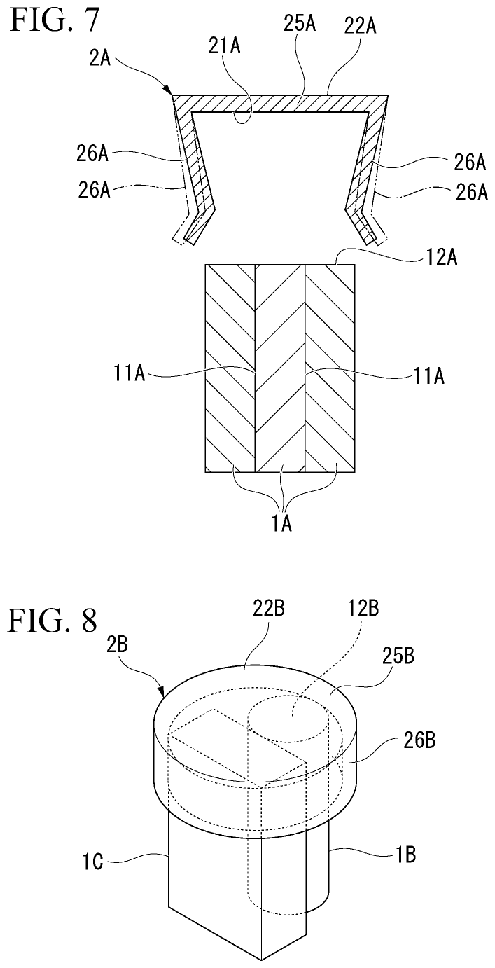

Since the three members to be joined 1A in the first embodiment overlap in the plate-thickness direction, a boundary 11A appearing on a boundary exposed surface 12A of the three members to be joined 11A is linear (in particular. see FIG. 5). The boundary exposed surface 12A of the three members to be joined 1A is a side surface of the members to be joined 1A extending in the alignment direction (left-right direction in FIGS. 6 and 7) of the three members to be joined 1A. The three members to be joined 1A are arranged so that the boundary exposed surface 12A of the three members to be joined 1A is flat. The number of the members to be joined 1A in the first embodiment is not limited to three, and may be two or four or more, for example.

An auxiliary member 2A in the first embodiment is formed by bending a plate-shaped member. The auxiliary member 2A is in the form of a clip having a facing portion 25A and a pair of wall portions 26A extending from both ends of the facing portion 25A. The facing portion 25A is formed in a flat plate shape having a rectangular shape in, plan view. Both surfaces (opposite surface 21A, opposite surface 22A) of the facing portions 25A facing opposite each other in the plate-thickness direction of the facing portions 25A are formed flat. The length between the pair of wall portions 26A in the facing portion 25A (i.e., the width of the facing portion 25A, in more detail, the width of the facing surface 21A) is longer than the dimension in the alignment direction of the three members to be joined 1A where the three members to be joined 1A are overlapped in the plate-thickness direction thereof. That is, the facing surfaces 21A of the facing portions 25A are arranged to face each other in the entire alignment direction of the boundary exposed surfaces 12A in the three members to be joined 1A.

The pair of wall portions 26A are bent and extended toward a side of the facing surface 21A from both ends of the facing portions 25A. The pair of wall portions 26A do not extend at right angles with respect to the facing portions 25A, but extend from both ends of the facing portions 25A in a state where the pair of wall portions 26A are inclined in a direction approaching each other. The pair of wall portions 26A are elastically flexible and deformable in a direction away from each other (and in a direction approaching each other) with a connection portion (bending portion) with the facing portion 25A as a fulcrum. A side of each of the tip end portions of the pair of wall portions 26A is bent and extended in a direction away from each other.

The auxiliary member 2A is attached to the three members to be joined 1A such that the facing surface 21A of the facing portion 25A is arranged to face the boundary exposed surface 12A of the three members to be joined 1A, and the three members to be joined 1A are sandwiched from the alignment directions thereof by the pair of wall portions 26A. In such a state, the flat facing surface 21A of the facing portion 25A facing the boundary exposed surface 12A comes into surface contact with the flat boundary exposed surface 12A. In addition, by elastically bending and deforming the pair of wall portions 26A in the direction away from each other, the three members to be joined 1A are sandwiched by the pair of wall portions 26A from the alignment direction, thereby, the three members to be joined 1A are held in a state of being joined. By sandwiching and holding the three members to be joined 1A by the pair of wall portions 26A, the three members to be joined 1A are prevented from moving with each other, and the three members to be joined 1A are fixed in a state for joining. The pair of wall portions 26A function as a movement restriction portion that restricts the relative movement of the three members to be joined 1A.

In the welding method of welding the three members to be joined 1A using the auxiliary members 2A, after the auxiliary members 2A are attached to the three members to be joined 1A as described above, the three members to be joined 1A are welded by a method which is similar to the method shown in FIGS. 1 to 4. That is, on the opposite surface 22A of the facing portion 25A of the auxiliary member 2A, the laser light LL is applied to the position where the boundary 11A of the two adjacent members 1A and the facing portion 25A overlap each other in the plate-thickness direction (or a region in the vicinity thereof). Since the boundary 11A of the member to be joined 1A exposed on the boundary exposed surface 12A is linear, the position where the laser light LL is applied with respect to the auxiliary member 2 is moved along the linear boundary 11A. At this time, the laser light LL may be applied along the boundary 11A so as to have a predetermined width such as a spiral shape or a sawtooth shape. Since the three members to be joined 1A have two boundaries 11A on the boundary exposed surface 12A, the laser light LL is applied to the positions corresponding to the two boundaries 11A, respectively.

When the laser light LL is applied in such a manner, the portion of the facing portion 25A that overlaps the boundary 11A of the member to be joined 1A melts from the opposite surface 22A side to the facing surface 21A side, and then the boundary portion of the two members to be joined 1A including the boundary 11A melts. Then, an alloy portion composed of a melted portion of the facing portion 25A and a boundary portion between the two melted members to be joined 1A is formed, and the two members to be joined 1A and the facing portion 25A are joined to each other by the alloy portion. Since the two boundaries 11A are exposed on the boundary exposed surface 12A of the three members to be joined 1A, the portions corresponding to the two boundaries 11A are irradiated with the laser light LL and joined in a similar manner as described above.

In the welded structure after welding the three members to be joined 1A, the pair of wall portions 26A of the auxiliary members 2A remain unmelted by the laser light LL. Therefore, even in the welded structure, the auxiliary member 2A is maintained in a state for joining the three members to be joined 1A.

Next, the second example of the present embodiment will be described with reference to FIGS. 8 to 10. The second example is a welding method and a welded structure in which two members 1B and 1C having different shapes are arranged so as to be in contact with each other and the two members to be joined 1B and 1C are welded.

The first member to be joined 1B in the second example is a member formed in a columnar shape extending in one direction. The second member to be joined 1C is a member formed in a square columnar shape extending in one direction. The first and second members to be joined 1B and 1C extend in the same direction and are arranged in a state where their outer surfaces are in contact with each other. A boundary exposed surface 12B of the first and second members to be joined 1B and 1C is the end surface of the two members to be joined 1B and 1C in the longitudinal direction. The first and second members to be joined 1B and 1C are arranged so that the boundary exposed surface 12B is flat. The first and second members to be joined 1B and 1C may be arranged in a state where the boundary exposed surface 12B is not flush with each other and has a slight step. In addition, the number of the members to be joined 1B and 1C in the second example is not limited to two, but may be three or more.

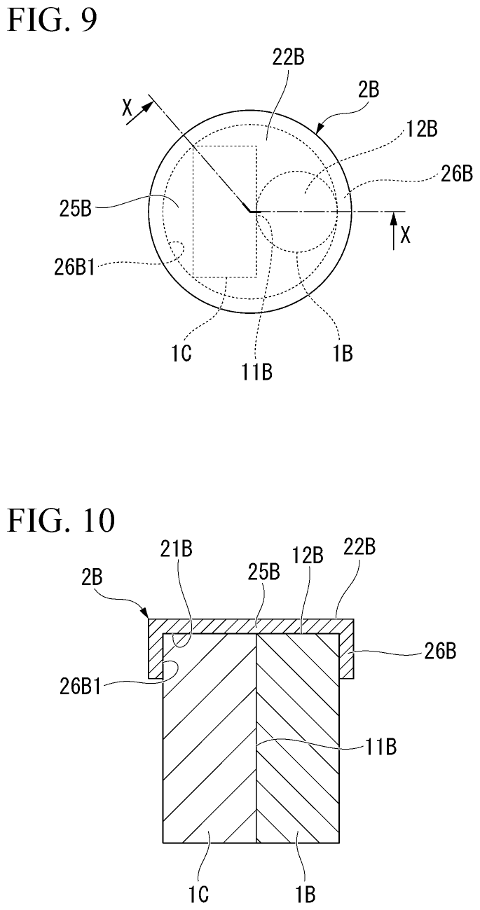

When the first and second members to be joined 1B and 1C are arranged as described above, the curved side surface of the first member to be joined 1B and the flat side surface of the second member to be joined 1C are close to each other. Therefore, a boundary 11B appearing on the boundary exposed surface 12B of the two members to be joined 1B and 1C is a dotted shape (see FIG. 9).

The auxiliary member 2B in the second example has a cap shape including a facing portion 25B and a peripheral wall portion 26B extending, from the peripheral end portion of the facing portion 25B. The facing portion 25B is formed in a circular plate shape in plan view. Both surfaces (facing surface 21B and opposite surface 22B) of the facing portions 25B facing opposite each other in the plate-thickness direction of the facing portions 25B are formed flat. The area of the facing surface 21B of the facing portion 25B is substantially the same as the area of the circumscribed circle of the boundary exposed surface 12B of the first and second members to be joined 1B and 1C. That is, the facing surface 21B of the facing portion 25B is arranged to face the entire boundary exposed surface 12B of the first and second members to be joined 1B and 1C.

The peripheral wall portion 26B extends from the peripheral end portion of the facing portion 25B toward the facing surface 21B side and is formed in a cylindrical shape. An inner peripheral surface 26B1 of the peripheral wall portion 26B is formed in a circular shape when viewed from the axial direction of the peripheral wall portion 26B. The circular area of the inner peripheral surface 26B1 of the peripheral wall portion 26B is the same as the area of the facing surface 21B of the facing portion 25B, and is almost the same size as the area of the circumscribed circle of the boundary exposed surface 12B of the first and second members to be joined 1B and 1C (see FIG. 9). The length of the axial direction of the peripheral wall portion 26B is shorter than the length of the longitudinal direction of the first and second members to be joined 1B and 1C.

The auxiliary member 2B is attached to the two members to be joined 1B and 1C such that the facing surface 21B of the facing portion 25B is arranged to face the boundary exposed surface 12B of the two members to be joined 1B and 1C, and the peripheral wall portion 26B surrounds the two members to be joined 1B and 1C. In such a state, the flat facing surface 21B of the facing portion 25B comes into surface contact with the flat boundary exposed surface 12B. In addition, the inner peripheral surface 26B1 of the peripheral wall portion 26B is circumscribed with respect to the side surfaces of the first and second members to be joined 1B and 1C (i.e., a state where the inner peripheral surface 26B1 of the peripheral wall portion 26B closely faces three points on the side surfaces of the two members to be joined 1B and 1C). As a result, the two members to be joined 1B and 1C are held in a state of being joined, and the movement of the two members to be joined 1B and IC is suppressed or prevented. The peripheral wall portion 26B functions as a movement restriction portion that restricts the relative movement of the two members to be joined 1B and 1C.

In the welding method in which the two members to be joined 1B and 1C are welded using the auxiliary members 2B of the second example, after the auxiliary members 2B are attached to the two members to be joined 1B and 1C as described above, the two members to be joined 1B and 1C are welded by a similar method as shown in FIGS. 1-4. That is, on the opposite surface 22B of the facing portion 25B of the auxiliary member 2B, the laser light LL is applied to the position (or a region in the vicinity thereof) where the boundary 11B of the two members to be joined 1B and 1C and the facing portion 25B overlap in the plate-thickness direction. Since the boundary 11B of the members to be joined 1B and 1C exposed on the boundary exposed surface 12B is dot-shaped, the irradiation position of the laser light LL on the auxiliary member 2 can be irradiated with almost no movement from the position of the boundary 11B.

When the laser light LL is applied in such a manner, the portion of the facing portion 25B that overlaps the boundary 11B of the two members to be joined 1B and 1C melts from the opposite surface 22B side to the facing surface 21B side, and then the boundary portion of the two members to be joined 1B and 1C including the boundary 11B melts. Then, an alloy portion composed of a melted portion of the facing portion 25B and a boundary portion between the two melted members to be joined 1B and 1C is formed, and the two members to be joined 1B and 1C and the facing portions 25B are mutually joined by the alloy portion.

In the welded structure after welding the two members to be joined 1B and 1C, the peripheral wall portion 26B of the auxiliary member 2B remains unmelted by the laser light LL. Therefore, even in the welded structure, the auxiliary member 2B is maintained in a state for joining the two members to be joined 1B and 1C.

As described above, according to the welding method of the first embodiment, in a state where the auxiliary member 2 having a greater laser absorption rate than the plurality of members to be joined 1 is opposed to the boundary exposed surface 12 of the plurality of members to be joined 1, the auxiliary member 2 is melted by applying the laser light LL to the auxiliary member 2. Then, the temperature of the boundary portion 13 of the plurality of members to be joined 1 can be increased by the melted portion 23 of the auxiliary member 2. As the temperature of the boundary portion 13 rises, the boundary portion 13 shifts to a state in which it easily absorbs the laser light LL, and the laser absorption rate of the boundary portion 13 increases. As a result, the boundary portion 13 is efficiently heated by the laser light LL, so that the boundary portion 13 can be melted and the plurality of members to be joined 1 can be welded. Therefore, even when it is difficult to perform laser welding even if the plurality of members to be joined 1 are directly irradiated with the laser light LL because the output of the laser light LL is small and the laser absorption rate of the plurality of members to be joined 1 is low, it becomes possible to easily weld the plurality of members to be joined 1.

In addition, according to the welding method and the welded structure of the first embodiment, the melting point of the auxiliary member 2 is greater than the melting point of the plurality of members to be joined 1. Therefore, the temperature of the melted portion 23 of the auxiliary member 2 melted by the laser light LL is greater than the melting point of the plurality of members to be joined 1. As a result, the boundary portion 13 of the plurality of members to be joined 1 is easily melted by the heat of the melted portion 23 of the auxiliary member 2. Therefore, the plurality of members to be joined 1 (in particular, the boundary portion 13) can be easily welded without being influenced by the size of the plurality of members to be joined 1.

In addition, in the welding method of the first embodiment, since the laser light LL is applied to the opposite surface 22 of the auxiliary member 2 facing the opposite side to the plurality of members to be joined 1, the auxiliary member 2 is first melted by the irradiation of the laser light LL, thereby, the temperature of the plurality of members 1 to be joined can be raised by the melted portion 23 of the auxiliary member 2. As the temperature of the plurality of members to be joined 1 rises, the plurality of members to be joined 1 shifts to a state in which the plurality of members to be joined 1 can easily absorb the laser light, and the laser absorption rate of the plurality of members to be joined 1 increases. As a result, the plurality of members 1 to be joined are heated not only by the heat of the melted portion 23 of the auxiliary member 2 but also by the laser light LL, so that the plurality of members 1 to be joined can be more reliably melted and welded.

In the welding method and welded structure using the auxiliary member 2A of the first embodiment and the auxiliary member 2B of the second embodiment, a plurality of movement restriction portions (a pair of wall portions 26A and peripheral wall portions 26B) of the auxiliary members 2A and 2B restrict the relative movement of the member to be joined 1. With such a movement restriction portion, it is possible to suppress variations in the relative positions of the plurality of members to be joined 1 that occur when the plurality of members to be joined 1 are assembled to be in a state of being joined. In addition, it is possible to prevent the members to be joined 1 from being relatively moved from the state in which the plurality of members 1 are joined. In addition, it is possible to prevent the gap between the adjacent members to be joined 1 from being excessively widened. In particular, since the auxiliary member 2A of the first example sandwiches the three members to be joined 1A, the gap between the members to be joined 1A can be minimized. In addition, in the auxiliary member 2B of the second example, since the inner peripheral surface 26B1 of the peripheral wall portion 26B surrounds the side surfaces of the two members to be joined 1B and 1C so as to be close to each other, the gap between the two members to be joined 1B and 1C can be suppressed to be small. From the above, it is possible to suppress welding defects due to excessive expansion of the gap between the members to be joined 1 and to stabilize the quality of welding.

In the first embodiment, in the facing surface 21 of the auxiliary member 2, the boundary exposed surface 12 of the plurality of members to be joined 1 is not limited to being formed as a flat surface and, for example, may be formed as a curved surface, an uneven surface, or the like. In such a case, the facing surface 21 of the auxiliary member 2 may be formed in a shape corresponding to at least the boundary exposed surface 12 so as to be in surface contact with the boundary exposed surface 12.

### Second Embodiment

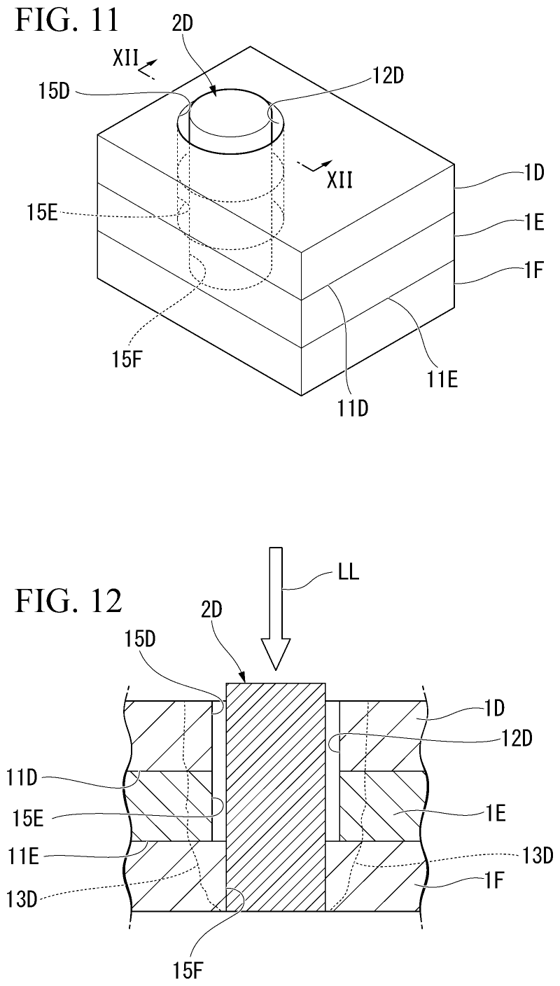

Next, a second embodiment of the present invention will be described with reference to FIGS. 11 to 13. The present embodiment is a welding method and a welded structure in which three flat plate-shaped members to be joined 1D, 1E, and 1F are arranged so as to be overlapped in the plate-thickness direction, and the three members to be joined 1D, 1E, and 1F are welded by using laser light LL.

As shown in FIGS. 11 and 12, in the welding method of the present embodiment, the three members to be joined 1D, 1E, and 1F and an auxiliary member 2D are first prepared as in the first embodiment. The materials and characteristics of the three members to be joined 1D, 1E, and 1F and the auxiliary member 2D are similar to those in the first embodiment.

The three flat plate-shaped members 1D, 1E, and 1F have through-holes 15D, 15E, and 15F penetrating in the plate-thickness direction (vertical direction in FIGS. 11 and 12). The through-holes 15D, 15E, and 15F are circular through-holes when viewed from the plate-thickness direction of the members to be joined 1D, 1E, and 1F. The auxiliary member 2D is formed in the shape of a cylindrical rod. The through-holes 15D and 15E of the two members to be joined 1D and 1E have substantially the same diameter. The diameter of the through-holes 15D and 15E is larger than the diameter of the auxiliary member 2D. The diameter of the through-hole 15F of the remaining one member to be joined 1F is substantially equal to the diameter of the auxiliary member 2D, and the auxiliary member 2D can be fitted into the through-hole 15F.

The three members to be joined 1D, 1E, and 1F are arranged so as to be overlapped with each other so that the three through-holes 15D, 15E, and 15F communicate with each other in the plate-thickness direction. The member to be joined 1F having the through-hole 15F having a small hole diameter is arranged at the end (bottom in FIGS. 11 and 12) of the three members to be joined 1D, 1E, and 1F in the alignment direction. In such a state, the boundaries 11D and 11E of the three members to be joined 1D, 1E, and 1F are exposed on the inner peripheral surfaces of the through-holes 15D, 15E, and 15F of the three members to be joined 1D, 1E, and 1F. That is, the inner peripheral surface of the through-holes 15D, 15E, and 15F is the boundary exposed surface 12D where the boundaries 11D and 11E of the three members to be joined 1D, 1E, and 1F appear.

The auxiliary member 2D is inserted into the through-holes 15D, 15E, and 15F of the respective three members to be joined 1D, 1E, and 1F arranged as described above. The auxiliary member 2D fits into the through-hole 15F of the member to be joined 1F having a smaller hole diameter among the three through-holes 15D, 15E, and 15F, and is fixed to the member to be joined 1F. In such a state, one end surface of the auxiliary member 2 is flush with the front surface of the member to be joined 1F (the surface opposite the boundary 11E), and the other end surface of the auxiliary member 2 is in a state of slightly protruding from the front surface of the member to be joined 1D (the surface opposite the boundary 11D).

In a state where the auxiliary member 2D is inserted into the three through-holes 15D, 15E, and 15F, the auxiliary member 2D is arranged so as to face the boundary exposed surface 12D formed by the inner peripheral surfaces of the through-holes 15D, 15E, and 15F of the respective three members to be joined 1D, 1E, and 1F. The auxiliary member 2D is fitted to the through-hole 15F of the member to be joined 1F having a small hole diameter as described above. For the through-holes 15D and 15E of the remaining two members to be joined 1D and 1E, there is a gap between the inner peripheral surface (boundary exposed surface 12D) of the through-holes 15D and 15E and the outer peripheral surface of the auxiliary member 2D. The auxiliary member 2D inserted in such a manner functions as a movement restriction portion that restricts the relative movement of the three members to be joined 1D, 1E, and 1F in the direction orthogonal to the alignment direction of the three members to be joined 1D, 1E, and 1F. That is, by arranging the auxiliary member 2D so as to face the boundary exposed surface 12D, the three members to be joined 1D, 1E, and 1F are maintained in the state for joining.

In the welding method of welding the three members to be joined 1D, 1E, and 1F using the auxiliary member 2D, the three members to be joined 1D, 1E, and 1F and the auxiliary member 2D are arranged as described above, and then as shown in FIG. 12, the auxiliary member 2D is irradiated with the laser light LL to melt the auxiliary member 2D. In particular, the laser light LL is applied to the other end surface of the auxiliary member 2D disposed at the auxiliary member 1D side, and the irradiation position of the laser light LL is moved from the center to the peripheral edge of the other end surface of the auxiliary member 2D, thereby, the auxiliary member 2D is melted. At this time, the laser light LL may be applied so as to move from the center to the peripheral edge of the other end surface of the auxiliary member 2D, for example, in a spiral shape. The melted portion of the auxiliary member 2D reaches the boundary exposed surface 12D of the three members to be joined 1D, 1E, and 1F. At this time, the portion of the auxiliary member 2 protruding from the member to be joined 1D fills the gap between the inner peripheral surfaces (boundary exposed surface 12D) of the through-holes 15D and 15E and the outer peripheral surface of the auxiliary member 2D.

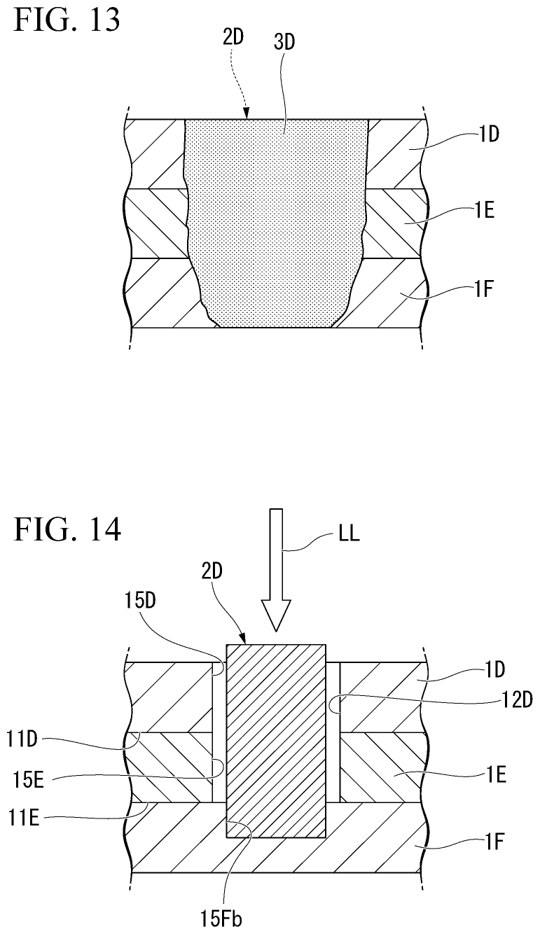

Then, the temperature of the boundary portion 13D of the three members to be joined 1D, 1E, and 1F rises due to the melted portion of the auxiliary member 2D, and the boundary portion 13D is melted by irradiating the boundary portion 13D with the laser light LL. When the temperature of the boundary portion 13D rises due to the melted portion of the auxiliary member 2D, the boundary portion 13D shifts to a state in which the laser light LL is easily absorbed, and the laser absorption rate of the boundary portion 13D increases. Then, as shown in FIG. 13, an alloy portion 3D including the components of the three members to be joined 1D, 1E, and 1F and the auxiliary member 2D is formed. The three members to be joined 1D, 1E, and 1F and the auxiliary member 2D are mutually joined by the alloy portion 3D. As described above, the welding method of the present embodiment in which the three members to be joined 1D, 1E, and 1F are welded is completed.

As shown in FIG. 13, the welded structure obtained by the welding method of the present embodiment includes, as in the first embodiment, three members to be joined 1D, 1E, and 1F, and the auxiliary member 2D inserted into the through-holes 15D, 15E, and 15F of the respective three members to be joined 1D, 1E, and 1F and arranged so as to face the boundary exposed surface 12D formed of the inner peripheral surfaces of the through-holes 15D, 15E, and 15F. In the welded structure, the three members to be joined 1D, 1E, and 1F and the auxiliary member 2D are mutually joined by the alloy portion 3D including the components of the three members to be joined 1D, 1E, and 1F and the auxiliary member 2D. The alloy portion 3D is a combination of the melted portion of the auxiliary member 2D and the melted portion of the three members to be joined 1D, 1E, and 1F in the above-described welding method. However, in the present embodiment, since the entire auxiliary member 2D is melted, the entire auxiliary member 2D is included in the alloy portion 3D in the welded structure. In such a welded structure, the portion on one end surface side of the auxiliary member 2D (the portion of the auxiliary member 2D disposed on the surface side of the member to be joined 1F) may remain without melting.

As described above, according to the welding method of the second embodiment, the same effect as that of the first embodiment is obtained. In addition, according to the welding method and the welded structure of the second embodiment, the auxiliary member 2D is inserted into the through-holes 15D, 15E, and 15F of the respective three members to be joined 1D, 1E, and 1F. With the auxiliary member 2D inserted in such a manner, it is possible to suppress variations in the relative positions of the three members to be joined 1D, 1E, and 1F that occur when the three members to be joined 1D, 1E, and 1F are assembled be a state of being joined. In addition, according to the welding method of the present embodiment, three or more members to be joined 1D, 1E, and 1F can be welded by applying single laser light.

In the welding method of the second embodiment, the shapes of the through-holes 15D, 15E, and 15F and the auxiliary member 2D viewed from the alignment direction of the three members to be joined 1D, 1E, and 1F are not limited to circular shapes, but may correspond to each other. In addition, the auxiliary, member 2D does not have to be configured to be fitted and fixed in the through-hole 15F of the member to be joined 1F, and is held in a state of being inserted into the three through-holes 15D, 15E, and 15F. The diameters of the three through-holes 15D, 15E, and 15F may be equal to each other or different from each other.

In the welding method of the second embodiment, the inner peripheral surfaces of the three through-holes 15D, 15E, and 15F may be inclined with respect to the alignment direction of the three members to be joined 1D, 1E, and 1F. For example, the inner peripheral surfaces of the three through-holes 15D, 15E, and 15F communicating with each other may be formed in a V-shaped or tapered cross section. In such a case, the auxiliary member 2D may be formed in a shape corresponding to the inner peripheral surface of the through-holes 15D, 15E, and 15F such as a conical shape or the like.

In the second embodiment, the auxiliary member 2D may include a flange portion that protrudes radially outward of the auxiliary member 2D at one end portion in the longitudinal direction. In such a case, with the auxiliary member 2D inserted into the through-holes 15D, 15E, and 15F of the respective three members to be joined 1D, 1E, and 1F, the flange portion of the auxiliary member 2D can be hooked on the member to be joined 1F disposed at the end in the alignment direction. Thereby, the auxiliary member 2D can be positioned with respect to the three members to be joined 1D, 1E, and 1F without fitting the auxiliary member 2D into the through-hole 15F of the member to be joined 1F. In the second embodiment, the number of members to be joined may be two or four or more.

In the welding method of the second embodiment, the members to be joined 1F arranged at one end of the three members to be joined 1D, 1E, and 1F in the alignment direction may include a recess 15Fb that opens to the boundary 11E side and into which the auxiliary member 2D can be inserted, as shown in FIG. 14 for example, instead of including the through-holes 15F. That is, the hole of the member to be joined 1F into which the auxiliary member 2D is inserted does not have to be penetrated. With such a configuration, it is possible to prevent the melted portion of the auxiliary member 2D from being exposed on the opposite side of the boundary 11E of the member to be joined 1F.

Although the details of the present invention have been described above, the present invention is not limited to the above-described embodiment, and various modifications can be made without departing from the gist of the present invention. For example, in the present invention, the auxiliary member may be made of a material having the same or lower melting point as the member to be joined. In addition, the type of laser used for irradiating the laser light is not limited to the one exemplified in the above-described embodiment, and may be appropriately selected depending on the material of the auxiliary member 2 and the member to be joined 1.

### REFERENCE SIGNS LIST

1, 1A, 1B, 1C, 1D, 1E, 1F: Member to be joined

2, 2A, 2B, 2C, 2D: Auxiliary member

3, 3D: Alloy portion

11, 11A, 11B, 11D, 11E: Boundary

12, 12A, 12B, 12D: Boundary Exposed surface

13, 13D: Boundary portion

15D, 15E, 15F: Through-hole

21, 21A, 21B: Facing surface

22, 22A, 22B: Opposite surface

23: Melted portion

25A, 25B: Facing portion

26A: Wall portion (movement restriction portion)

26B: Peripheral wall portion (movement restriction portion)

LL: Laser light

1-9. (canceled)

10. A welding method comprising:
arranging a plurality of members to be joined in a state in which each of the plurality of members to be joined is in contact with each other;
arranging an auxiliary member having a greater absorption rate of a laser light than the plurality of members to be joined so as to face a boundary exposed surface of the plurality of the members to be joined where a boundary of the plurality of the members to be joined is exposed;
maintaining the plurality of members to be joined in an arrangement state in which each of the plurality of members to be joined is in contact with each other by the auxiliary member;
melting the auxiliary member by applying a laser light to the auxiliary member;
shifting a boundary portion in a state where a laser light is easily absorbed by increasing a temperature of the boundary portion of the plurality of members to be joined by a melted portion of the auxiliary member; and
welding a plurality of members to be joined by applying a laser light to the boundary portion and melting the boundary portion.

11. The welding method according to claim 10, wherein a melting point of the auxiliary member is greater than a melting point of the plurality of members to be joined.

12. The welding method according to claim 10, wherein the laser light is applied to an opposite surface of the auxiliary member facing an opposite side with respect to a facing surface of the auxiliary member facing the plurality of members to be joined.

13. The welding method according to claim 10, wherein the auxiliary comprises:
a facing portion with a plate shape arranged so as to face the boundary exposed surface; and
a pair of wall portions extending from both end portions of the facing portion and sandwiching the plurality of members to be joined from a direction where the plurality of members to be joined is aligned.

14. The welding method according to claim 10, wherein the auxiliary member comprises:
a facing portion with a plate shape arranged so as to face the boundary exposed surface; and
a peripheral wall portion extending from a peripheral end portion of the facing portion and surrounding the plurality of members to be joined.

15. The welding method according to claim 10,
wherein the plurality of members to be joined each have a hole that communicates with each other in a direction where the plurality of members to be joined is aligned, and
wherein the auxiliary member is formed in a rod shape and inserted into each of the plurality of holes.

16. A welded structure comprising:
a plurality of members to be joined arranged in a state in which each of the plurality of members to be joined is in contact with each other; and
an auxiliary member arranged so as to face a boundary exposed surface of the plurality of members to be joined where a boundary of the plurality of members to be joined is exposed and having a greater absorption rate of a laser light than the plurality of members to be joined to each other;
the auxiliary member is arranged so as to face the boundary exposed surface, thereby has a function that maintain the plurality of members to be joined in an arrangement state in which each of the plurality of members to be joined is in contact with each other; and
the plurality of members to be joined and the auxiliary member are joined to each other by an alloy portion comprising components of the plurality of members to be joined and the auxiliary member.
